(19) United States
(12) Patent Application Publication
(10) Pub. No.: US 2006/0218424 A1
(43) Pub. Date: Sep. 28, 2006

(54) Integrated circuit with autonomous power management

(76) Inventors: Miron Abramovici, Berkeley Heights, NJ (US); Paul A. Bradley, Cumberland, RI (US); Peter L. Levin, Newtonville, MA (US); Gerard Memmi, Cambridge, MA (US)

Correspondence Address: MCDERMOTT WILL & EMERY LLP;ATTN: INTELLECTUAL PROPERTY DEPTARTMENT, 28 STATE STREET, BOSTON, MA, 02109, US

(21) Appl. No.: 11/088,021

(22) Filed: Mar. 23, 2005

(51) Int. Cl. G06F 1/00

(52) U.S. Cl. 713/323

(57) ABSTRACT

An autonomous on-chip power management system for managing power consumption of an functional block in an integrated circuit includes power management circuitry configured to monitor signals relevant to the function of the functional block for detecting a predetermined condition associated with the signals, and, in response to the detection of the predetermined condition, to set the functional block to a power saving mode, and, in response to the detection of a predetermined reactivating condition associated with the signals, to set the functional block to a normal operational mode.

### FIELD OF THE INVENTION

This invention relates to integrated circuits, and more particularly, to methods and apparatus for autonomously reducing power consumption for integrated circuits.

### BACKGROUND OF THE INVENTION

High-speed operation of integrated circuits generally leads to high power consumption. One goal in designing an integrated circuit is to reduce power consumption, especially for portable electronic devices. Because the power consumed by an integrated circuit is proportional to the clock frequency and the applied voltage of the integrated circuit, the conventional approaches for reducing power consumption have focused on clock and voltage scaling. These conventional approaches include a) reducing the operating voltage of the integrated circuit, b) reducing the clock frequency of the integrated circuit, and c) shutting off the clock to the integrated circuit.

In these conventional approaches, various algorithms are used to determine when to initiate power saving controls. In general these algorithms are software based and execute on a processor that resides on-chip or off-chip.

These conventional approaches generally require that the integrated circuit designer make provisions in the design to allow the software to monitor activities (variables) and thereby to control power management functions. However, as integrated circuits become more complex and more flexible/programmable, it is difficult for the integrated circuit designers to anticipate the applications for their chip and thus to anticipate what signals or variables should be monitored for power management. Furthermore, while in use, because of the complexity and the large-scale integration of the circuit, the “visibility” of the operation of individual blocks or cores is limited. Thereby, it becomes difficult for the designers or users to decide when and which sections of the integrated circuit should be disabled or voltage or frequency of which should be scaled for power saving.

Moreover, the conventional approaches typically rely on a centralized decision mechanism for power management having the power management software run on one processor to control the power consumption of large system blocks and peripherals. These conventional techniques often fail to monitor activity and functionality of individual blocks or cores and thereby fail to manage power consumption at a block or core level. In these conventional approaches, if one core of a large system block is functioning, the system may have to keep the whole system block working. Therefore, the power saved by these conventional approaches is limited.

Accordingly, there is a need for a new approach to locally and dynamically manage power consumption of individual blocks or cores of an integrated circuit. SUMMARY

The present invention is directed to addressing the above need by way of an autonomous on-chip power management system, which has power management circuitry distributed in an integrated circuit. An integrated circuit generally employs a multi-core or block data processing structure on a semiconductor chip. The term “core” designates pre-packaged design modules that a designer of an integrated circuit employs, usually without any changes. The distributed power management circuitry is able to monitor activities of cores or other functional blocks, providing greater visibility of the operation of cores or functional blocks, and thereby is able to manage power consumption of individual cores or functional blocks locally. The dynamic localized power management can be performed faster than centralized mechanism used in the prior art approaches, thus enabling more real-time applications of power management. The power management system of the present invention is also able to determine an optimal setting in real-time for a particular integrated circuit design to achieve most effective power saving. It achieves this without any change to the operating system of the device, and without any change to the software application it supports. Hence, it is labeled as “autonomous power management system”.

According to one aspect of the present invention, the power management system of the present invention includes power management circuitry connected to a functional block, which includes a core, a group of cores, or a part of a core, for managing the power consumption of the functional block. The power management circuitry is preferably implemented in the form of circuit blocks distributed among the multiple cores of the integrated circuit.

The power management circuitry may include fixed logic circuits, or alternatively, include at least partially reprogrammable or reconfigurable logic circuits, to observe signals transmitted in the integrated circuit, and based on certain conditions in the observed signals, to set the functional block to a power saving mode. The power management circuitry including at least partially reprogrammable or reconfigurable logic circuits provides the user with the ability of dynamically changing the predetermined conditions under which the functional block should be set to the power saving mode. The reconfigurable circuits also enable the user to fix functional errors in the power management circuitry, as well as functional errors in the integrated circuit, after the integrated circuit has been fabricated.

Functional blocks generally include sequential logic circuits and/or combinational logic circuits. The power management circuitry, according to one aspect of the present invention, is adapted to reduce the clock speed of a system clock associated with the sequential logic circuits of a functional block, and/or to gate off the inputs to the combinational logic circuits of the functional block, and thereby to reduce power consumption of said functional block.

In one preferred embodiment, the power management circuitry includes a controller that is configured to monitor signals associated with a particular functional block, for example signals at the inputs and/or outputs of the functional block or signals remote to the functional clock but related to the function of the functional block, or other signals, for detecting a predetermined condition associated with the signals. The controller is configured to “anticipate” what the state that the block will be, for example, a normal-operational or a power saving mode (partially-operational or non-operational mode), from monitoring the signals at the input and/or outputs of the functional block. In response to the detection of the predetermined condition, the controller sets the functional block to a power saving mode. In response to the detection of another predetermined condition (hereinafter referred as reactivating condition) under which the functional block should be in normal operational mode, the controller sets the functional block to the normal operational mode.

In one preferred embodiment, the power management circuitry includes registers for specifying and storing data indicative of the predetermined condition. For example, the power management circuitry may include two registers for storing numerical values, such as values representative of digital or analog signals. In one preferred form, one register stores a high digital value and the other stores a low digital value, where the “predetermined condition” is defined as being present when a monitored value is between the high and low digital values. This situation may be reversed in other embodiments, that is, the predetermined condition is that the monitored signal is outside the range defined by the upper and lower digital values. In one preferred form, the registers are user-settable so that a user can modify the definition of the “predetermined condition” to be a desired range.

The power management circuitry may further include a counter connected to the controller, which includes a register for specifying additional information representative of the defined predetermined condition. For example, the register of the counter can be set to specify a predetermined duration, and in use, the counter counts the time that the monitored signals are outside the range defined by the low and high numerical values. In this case, the predetermined condition may be defined to occur when the signals at the inputs and/or outputs are outside the range defined by the low and high numerical values for the predetermined duration.

According to another aspect of the present invention, the power management circuitry includes a clock control circuit coupled to the controller and a system clock of the functional block. In general, the system clock generates a clock signal to drive the functional block. The clock control circuit is adapted to decrease the speed of the clock signal or disable the clock signal to the functional block in response to instructions from the controller (in other words, the clock rate is lowered or set to be zero), and thereby to set the functional block to a power saving mode.

According to a further aspect of the present invention, the power management circuitry further includes an input control circuit coupled to the inputs of the functional block. The input control circuit is connected to and controlled by the controller. The input control circuit is adapted to disable the input signals to the functional block in response to the detected predetermined condition, and in response to the detected reactivating condition, to enable the input signals to the functional block.

In response to the reactivating conditions in the signals at the inputs and/or outputs of the functional block, the power management circuitry should reactivate the functional block by enabling the clock signal and the input signals. One key issue in reactivation of the functional block is that data may be lost during the reactivation because of the delayed response of the power management circuitry and the functional block. The present invention includes several forms to resolve such issues. According to one preferred form of the invention, data loss is avoided by driving the power management circuitry with a clock signal, which has a faster clock speed than the clock signal of the system clock, or alternatively, is a phase-shifted version of the clock signal of the system clock. According to another preferred form, the controller monitors a signal that is associated to the functional block but is remote from the functional block. In these embodiments, the controller is able to detect the reactivating condition in the monitored signals in a relatively early time frame and enables the clock signal and the input signals to the functional block correspondingly earlier, so that the functional block is able to capture the signals at the inputs without losing any data.

In a further preferred embodiment, the power management circuitry includes a pipeline connected between the input of the functional block and the controller, and a multiplexer connecting the input and an output of the pipeline to the functional block. The multiplexer is configured to select signals from either the input or the output of the pipeline to be passed through the multiplexer to the functional block.

The user designed integrated circuit may have a pipeline coupled at the input of the functional block. In this case, the input signals passing through the pipeline may be delayed by the pipeline with “n” cycles, where “n” is the number of pipeline registers of the pipeline. The power management circuitry, which monitors the input signal before they enter the pipeline has “n” cycles to reactivate the functional block without losing any data.

As described above, a customer designed integrated circuit generally includes multiple cores or functional blocks. As disclosed in the related patent application, an on-chip reconfigurable wrapper can be coupled to the cores and to reconfigure the functionality of the cores. In one preferred embodiment of the present invention, the power management circuitry as described above is implemented in the reconfigurable wrapper for managing power consumption of a functional block.

### BRIEF DESCRIPTION OF THE DRAWINGS

FIG. 1 shows a diagram of a power management system including multiple power control blocks distributed in an integrated circuit according to one preferred embodiment of the present invention;

FIG.2 shows a diagram of power management circuitry associated with a functional block according to one preferred embodiment of the present invention;

FIG.3 shows a diagram of power management circuitry associated with a functional block according to another preferred embodiment of the present invention;

FIGS.4A-4C show timing diagrams of signals and clocks of the preferred embodiments of the present invention;

FIG.5 shows a diagram of the power management circuitry associated with a functional block according to a further preferred embodiment of the present invention;;

FIG.6 shows a data flow diagram of the embodiment in FIG.5 according to the present invention;

FIG.7 shows a diagram of the power management circuitry associated with a functional block according to another preferred embodiment of the present invention;

FIG. 8 shows a wrapper design in accord with the principles of this invention; and

FIG. 9 shows the structure of output and input cells, and the use of spare lines between FRMs of a wrapper.

### DETAILED DESCRIPTION OF PREFERRED EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

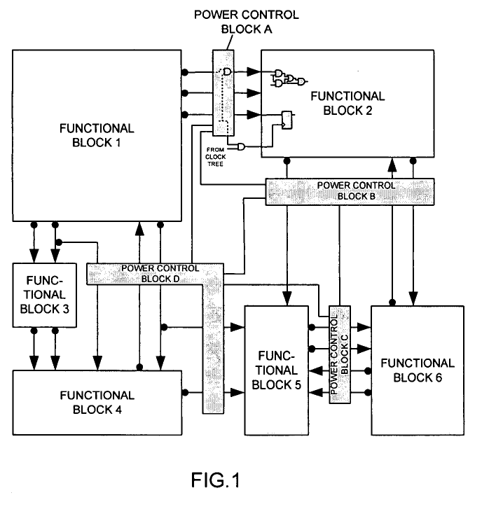

FIG. 1 illustrates a diagram of an autonomous distributed power management system coupled with multiple functional blocks (functional blocks 1-6 in FIG. 1) in an integrated circuit. The functional block can be a user defined logic block, or a third party's core, or other forms. The autonomous power management system, according to the present invention, includes power management circuitry, which is preferably implemented in the form of circuit blocks distributed among the multiple blocks of the integrated circuit. The circuit blocks indicated as power control blocks A-D in FIG. 1 are connected to interconnects in the integrated circuit to observe signals transmitted in the integrated circuit, and based on certain conditions in the observed signals, to set one or more particular functional blocks to a power saving mode.

As shown in FIG. 1, the power control blocks can be placed at any desired location or coupled to any desired wires to monitor certain signals and to decide whether to set a particular functional block to a power saving mode. In one exemplary form, the power control blocks A and B are coupled to the inputs and outputs of the functional block 2 to monitor the input and output signals and in response to the detection of predetermined conditions associated with the input and/or output signals to set the functional block 2 to a power saving mode. In another exemplary form, the power control block D, which is not directly coupled to the functional block 2, may be configured to monitor signals, which are remote to the functional block 2 but are related to the function of the functional block 2, to decide whether the functional block 2 should be set to a power saving mode. Under predetermined conditions in the monitored signals, the power control block D may send a control signal to the power control block A through the interconnect between the power control blocks to enable the power control block A to set the functional block 2 to a power saving mode.

The functional block generally includes sequential logic circuits and/or combinational logic circuits. The sequential logic circuits are associated with a clock signal. As shown in FIG. 1, in one preferred embodiment, the power management circuitry is configured to reduce the clock speed of the clock signal associated with the sequential logic circuits, and/or to gate off the input to the combinational logic circuits of the functional block, preventing the transistors in the combinational circuits from switching on and off, and thereby to reduce power consumption of the functional block.

According to one preferred form of the present invention, the power management circuitry is configured with fixed logic circuits. According to another preferred form of the present invention, the power management circuitry includes at least partially reprogrammable logic circuits.

In one form, the power management circuitry is configured to monitor “enabling signals”, the value of which decides whether a functional block is in a “don't care” situation. For example, if a functional block outputs its result through an AND gate, another input signal of such AND gate will be an “enabling signal” to the functional block, and if the “enabling signal” is “0”, the output of the AND gate will be “0”, no matter what the result of the functional block would be. When the “enabling signal” is “0”, the functional block is in a “don't care” situation, and should be set to a power saving mode. Alternatively, the power management circuitry can be configured such that only when the “enabling signal” remains being “0” for a certain time period, the functional block is set to a power saving mode.

The “enabling signal” currently being “0” or being “0” for a certain duration is one type of predetermined conditions in the monitored signals under which the power management circuitry sets the associated functional block to a power saving mode. Such predetermined conditions can be other forms, for example, activities at the input and/or output of a functional block, such as the monitored value being below a predetermined certain value or over a predetermined certain value, instructions from a higher level control mechanism to set the functional block to a power saving mode, etc.

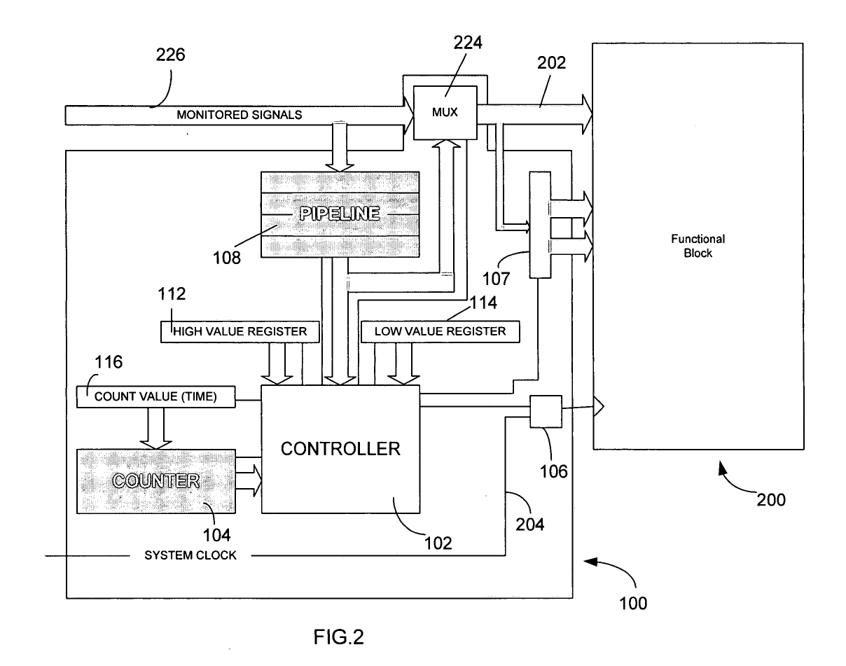

Exemplary power management circuitry embodying the invention is illustrated in detail in FIGS.2-9. There are many other relevant examples of power management that embody the concept of the present invention but do not involve a counter and upper/lower threshold value registers for monitoring signals in the integrated circuit as depicted in FIGS.2-9. Examples include, but not limited to, simple pattern matching, applying numerical calculation to data stream, creating data stream state machine to track a sequence of signal states/values.

FIG. 2 illustrates a diagram of power management circuitry 100 coupled to an input 202 and a system clock 204 of a functional block 200 in accordance with one preferred embodiment of the present invention. The power management circuitry 100 is designed to control the system clock 204 and/or the input signals of the functional block 200, and thereby to slow down or turn off the clock signal and/or to gate off the input signals to the functional block 200 to reduce power consumption of the functional block 200. In one preferred form, as shown in FIG.2, the power management circuitry 100 includes a controller 102, a counter 104, a clock control circuit 106, and an input control circuit 107. The input signals from an interconnect 226 of the functional block 200 are coupled, preferably through a pipeline 108 (e.g., a FIFO), to the controller 102, which monitors the incoming signals to detected predetermined conditions, under which the functional block 200 should be set to a power saving mode.

As shown in FIG.2, in one preferred embodiment, the controller 102 includes a high value register 112 and a low value register 114 for specifying the predetermined conditions, for example, numerical values for a group of signals. In one preferred form, the numerical values are digital values. The numerical values stored in the high value register 112 and the low value register 114 respectively are upper and lower numerical values for the input signals. The high value register 112 and low value register 114 are preferably user-settable, and therefore, the predetermined conditions can be changed by a user as desired. The controller 102 includes a comparator for comparing the monitored input signals to the preset upper and lower numerical values. If the monitored input signals are between the upper and lower numerical values, the controller 102 may send a control signal to the clock control circuit 106 and/or input control circuit 107 to turn off the clock signal and/or the input signals to the functional block 200. The predetermined condition may be that the monitored signal is between the upper and lower numerical values. This situation may be reversed in other embodiments, that is, the predetermined condition is that the monitored signal is outside the range defined by the upper and lower numerical values. The controller 102 may include reconfigurable logic circuits, or alternatively, the controller 102 is constructed with fixed-logic circuits. In one preferred form, the controller 102 is configured to allow the functional block 200 to finish its current execution before the controller 102 turns off the clock signal and/or the input signals.

The counter 104 is connected to the controller 102. The counter 104 preferably includes a loadable register 116 used to specify a counter value, which can be used as another predetermined condition. The monitored input signals are transmitted through the pipeline 108 and the controller 102 to the counter 104. The counter 104 can be used to count time period for which an input signal is in the predetermined condition as set by the controller 102. When the time period reaches the specified count value stored in the counter 104, the counter 104 triggers the controller 102 to send a control signal to the clock control circuit 106. In other forms, the counter 104 can be configured to count other values, for example, to count the number of times that a pattern occurs in the monitored signals.

The clock control circuit 106 may be configured to slow down the speed of the clock or to disable the clock signal 204 to the functional block 200. For example, the clock control circuit 106 can be configured to switch the clock signal from a higher clock rate to a lower clock rate in a power saving mode. For another example, the clock control circuit 106 may include an AND gate, where the system clock 204 is connected to one input of the AND gate and the controller 102 is connected to another input of the AND gate. When in a power saving mode as determined by the controller 102, the controller 102 sends a logic low signal (i.e., “0”) to the AND gate to disable the clock signal to the functional block 200.

The input control circuit 107 is configured to disable input signals to the functional block 200. For example, the input control circuit 107 may include a plurality of AND gates each having an input coupled to an input interconnect of the functional block and the other input coupled to the controller 102, and an output coupled to the input pins of the functional block 200. In response to a logic low signal generated by the controller 102, the AND gates disable the associated input signal to the functional block 200.

As described above, in one preferred form, the registers in the controller 102 and the counter 104 are reprogrammable, and thereby, the predetermined conditions, which are specified in these registers can be modified as desired by a user. Either the controller 102 or the counter 104 can be configured to be used as a comparator to determine whether the input signals meet the predetermined condition. Alternatively, as described in the following exemplary embodiment, the controller 102 and counter 104 can be configured to be used as a whole to set multiple conditions, and only when the input signals meet the multiple conditions, the controller 102 sends control signals to the clock control circuit 106 and the input control circuit 107 to set the functional block 200 to the power saving mode.

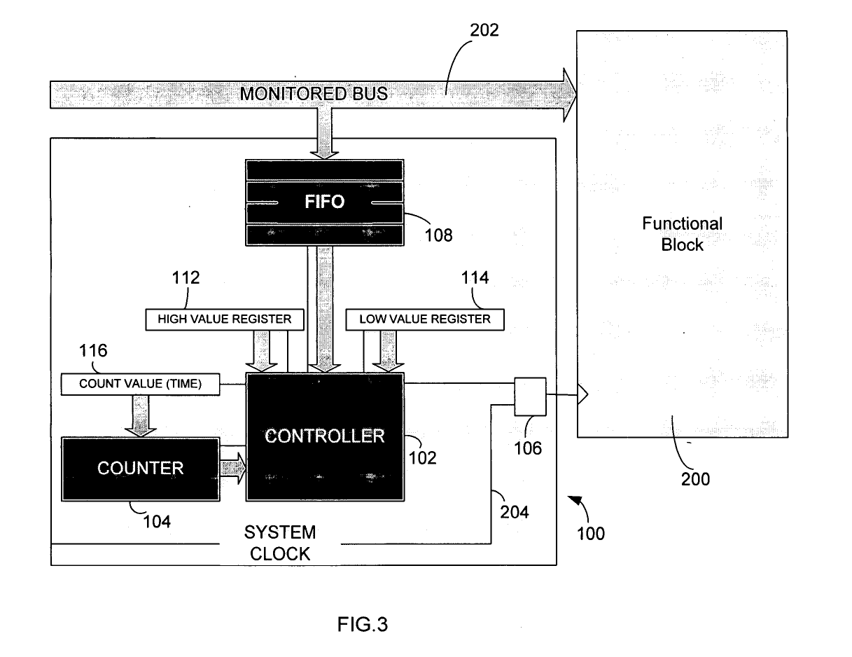

FIG.3 illustrates an exemplary embodiment of the power management circuitry which can be used in audio devices, such as MP3 players, in accordance with the present invention. As shown in FIG.3, the power management circuitry 100 includes a controller 102, a counter 104, and a clock control circuit 106. An input data bus 202, which transmits input signals to the functional block 200, is connected to the controller 102 via an FIFO pipeline 108. The controller 102 includes a high value register 112 and a low value register 114, which store a high and a low numerical values representative of the predetermined condition. The counter 104, which is connected to the controller 102, specifies a duration. The controller 102 and the counter 104 monitor the input signals in the input 202 to determine whether the sound signal is outside the lower and higher values for the specified duration. If the signal is outside the lower and higher values for the specified duration, the predetermined condition is met, which triggers the controller 102 to send a control signal to the clock control circuit 106 to slow down or turn off the clock, and thereby to set the functional block 200 into a power saving mode. For example, when the amplitude of the signal is below the low numerical value, it may be considered as noise without desired signal being transmitted, and if the situation continues for the predetermined duration, the predetermined condition is met. When the amplitude of the signal is greater than the high numerical value, it may be considered as distortion, and if, in the predetermined duration, it happens with a certain number of pulses, the predetermined condition is also met.

FIGS. 2 and 3 show that the power management circuitry 100 is coupled to the input of the functional block 200. Alternatively, the power management circuitry 100 may be coupled to the output of the functional block 200, and the controller 102 monitors the output signals to determine whether the functional block 200 should be set into a power saving mode.

The power management circuitry 100 is also adapted to reactivate the clock signal 204 and the input signals to the functional block 200 when the controller 102 detects another predetermined condition (hereinafter referred as reactivating condition) under which the functional block should be reactivated to a normal operational mode. The reactivating condition can be an instruction signal for reactivating a particular functional block, occurrence of a signal that is not in the predetermined condition under which the functional clock 200 should be in the power saving mode, or other forms. For example, if the output of the functional block is coupled to an AND gate with an “enabling signal”, the reactivating condition can be that the “enabling signal” has a value of “1”. Upon detection of the reactivating condition, the controller 102 sends a control signal to the clock control circuit 106 and the input control circuit 107 to activate the clock and the input to the functional block 200. For example, if the clock control circuit 106 is an AND gate as described above, the controller 102 may send a logic high signal, i.e. “1”, to the AND gate to enable the clock signal to the functional block 200.

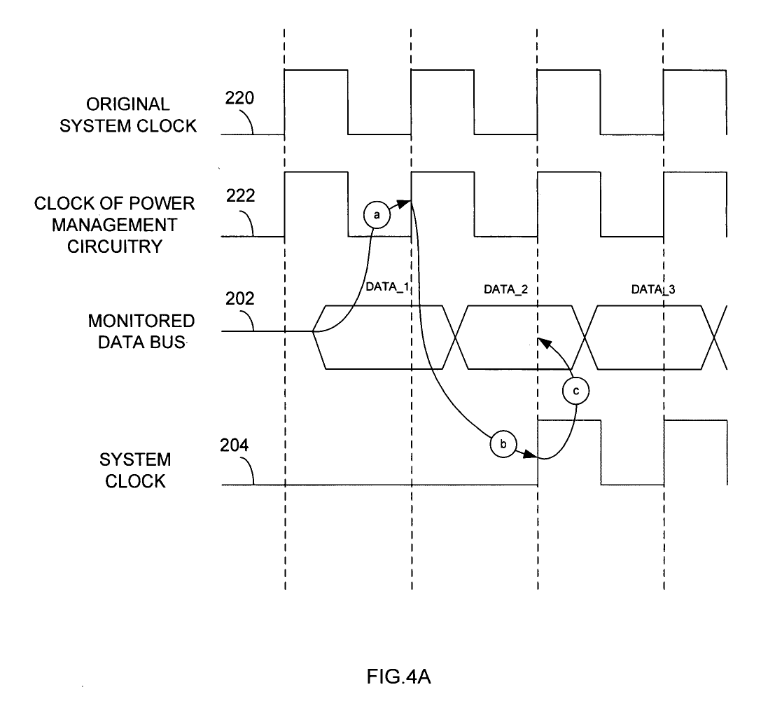

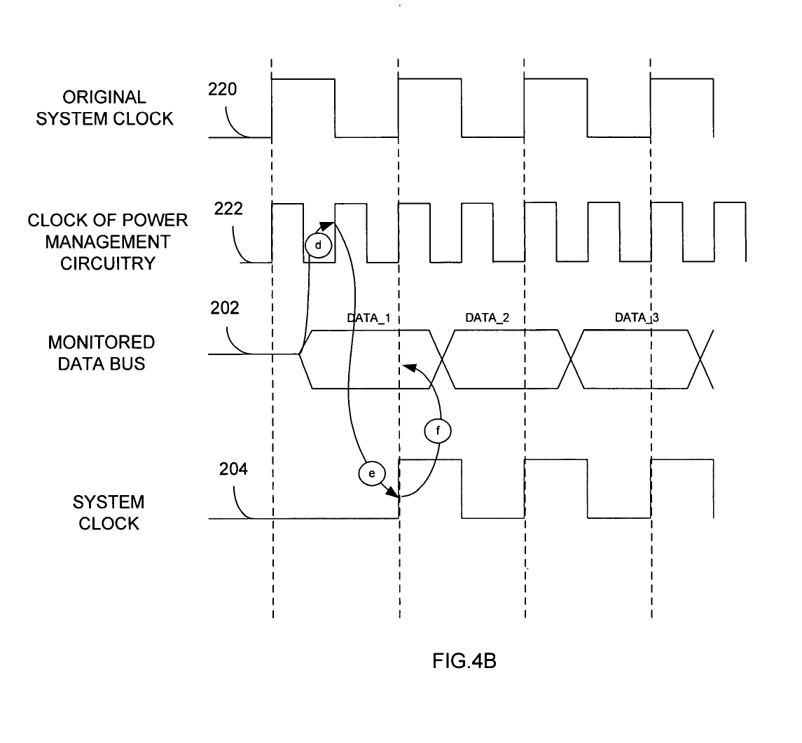

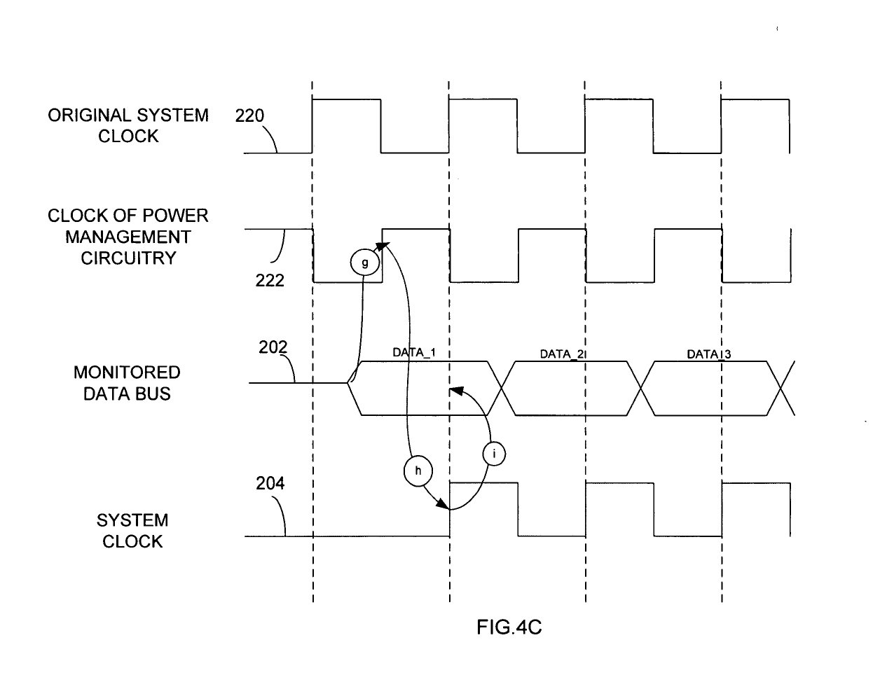

A key issue in reactivating the functional block 200 is how to reactivate the functional block on time without losing any data. FIG.4A shows a conventional way to reactivate the system clock in which a beginning part of the transmitted signal may be lost during the reactivating process. FIGS.4B and 4C illustrate two methods of reactivating the clock signal of the functional block 200 without losing data. In FIGS.4A-4C, an original system clock 220 is depicted to be used only for purpose of illustrating the timing of the system and is not a real clock signal used in the power management circuitry 100 or the functional block 200. The original system clock 220 has the same clock rate as the normal operational clock rate of the functional clock 200.

In FIG.4A, the power management circuitry 100 operates on an operating clock 222 which has the same frequency as the system clock 204. When a reactivating signal, as indicated by DATA_1, appears at the monitored input data bus 202, the controller 102 will detect the reactivating signal DATA_1 at the rising edge (a) of the operating clock 222. Subsequent to the detection of the reactivating condition, the power management circuitry 100 enables the system clock 204 to the functional block 200 at a next rising edge, as indicated by (b), of the system clock 204. The system clock 204 drives the functional block 200 to the operational mode at the rising edge (b) of the system clock 204, and the reactivated functional block 200 starts to capture signals from the input data bus 202 as indicated by arrow (c). As shown in FIG.4A, at this time, the functional block 200 is able to capture DATA_2, and DATA_1 is lost.

FIG.4B shows one method for reactivating the clock signal of the functional block 200 without losing data. In this embodiment, the power management circuitry 100 operates on an operation clock 222, which has a clock rate greater than the clock rate of the system clock 204. In the exemplary embodiment in FIG.4B, the clock rate of the power management circuitry 100 is two times of the clock rate of the system clock 204. With this faster clock speed, the power management circuitry 100 will detect the reactivating condition in the monitored input data bus 202 at a rising edge (d), which is earlier than the time (a) in the embodiment in FIG.4A. Consequently, in response to the detection of the reactivating condition, the controller 102 enables the system clock 204 to the functional block 200 at a rising edge (e), which is earlier than the enabling time (b) in the embodiment in FIG.4A. In this embodiment, the functional block 200 is able to capture DATA_1, as indicated by arrow (f), without losing any data in the reactivation process. One disadvantage of this embodiment is that because the power management circuitry 100 operates at a faster clock speed, the power management circuitry 100 will consume more power than the embodiment in FIG.4A.

FIG.4C shows a further method for reactivating the clock signal of the functional block 200. In the embodiment shown in FIG.4C, the power management circuitry 100 operates on the operation clock 222, which is a phase-shifted version of the system clock 204 of the functional block 200. In the exemplary embodiment, the clock of the power management circuitry 100 is shifted in its phase from the system clock 204 by exactly one half of a clock cycle (or 180 degrees). Alternatively, the clock signal may be shifted by other fractions of the clock cycle. As shown in FIG.4C, the power management circuitry 100 detects the reactivating condition in the monitored input data bus 202 at a rising edge (g), and turns on the system clock 204 of the functional block 200 at a rising edge (h) of the system clock 204. At this time (the rising edge (h)), the system clock 204 of the functional block 200 is enabled, and driven by that clock signal, the functional block 200 captures DATA_1, as indicated by arrow (i).

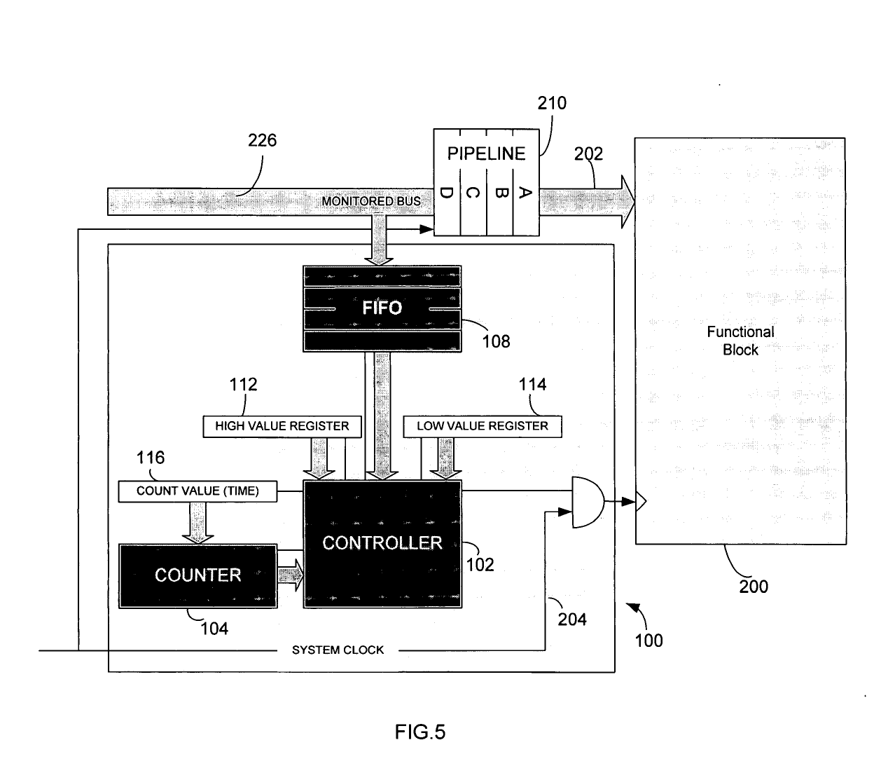

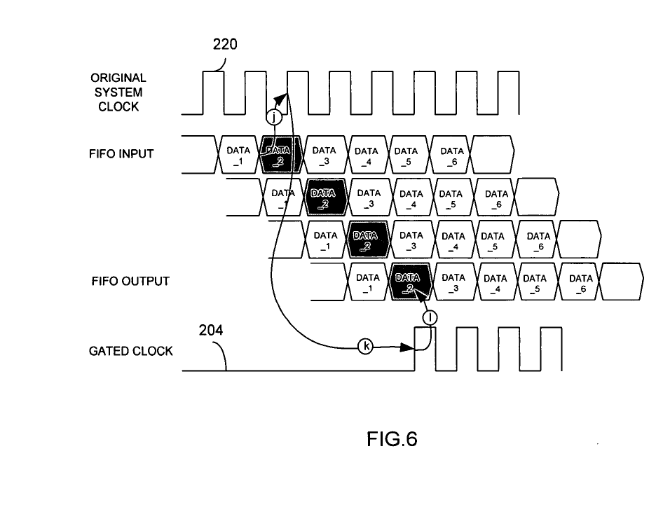

FIG.5 illustrates another exemplary embodiment of the power management 100, which is used with a customer designed circuit including a user defined functional block 200, a system clock 204, an input data bus 202, and a pipeline 210 at the input of the functional block 200. The input signals from the interconnect 226 pass through the pipeline 210 and enter into the functional block 200. The functional block 200 and the pipeline 210 are both driven by the system clock 204. The power management circuitry 100 for the functional block 200 is similar to the power management circuitries shown in FIGS.2 and 3, except that the reactivating mechanism used in this situation (the input signals are pipelined into the functional block) may be slightly different, which is described in detail below and together with the timing diagram in FIG.6.

FIG.6 illustrates the timing diagram showing the clock signals and data transitions in the monitored input data bus 202 of the functional block 200, where the input data is pipelined before enters into the functional block 200. The original system clock 220, which has the same clock rate as the system clock 204, is used only for purpose of illustrating the timing of the system and is not a real clock signal used in the power management circuitry 100 or the functional block 200. As shown in the example in FIG.6, the pipeline 210 (for example, a FIFO) has four pipeline registers. In the FIFO input, DATA_2 appears in the FIFO input at a rising edge (j). At the next rising edge of the original system clock 220, DATA_2 moves to the next register of the FIFO pipeline, and at the fourth rising edge (indicated by (k)) following the rising edge (j), DATA_2 arrives at the FIFO output. The power management circuitry 100, which is coupled to the input of the pipeline 210, is able to detect the active signal, for example, DATA_2, before it enters the pipeline. Thereby, the power management circuitry 100 may turn on the system clock 204 at any time between the rising edge (j) and the rising edge (k), and in this time period (four cycles), the functional block 200 is able to capture DATA_2, as indicated by arrow (l). Therefore, if the input pipeline 210 has “n” pipeline registers, the power management circuitry 100 has “n” cycles to turn on the system clock to the functional block 200 without losing any data.

In a preferred embodiment, the power management circuitry 100 may include a pipeline, which receives the input signals from the interconnect 226 and which can be used to delay the input signals to the functional block 200. As shown in FIG.2, the power management circuitry 100 includes the pipeline 108 connected between the interconnect 226 and the controller 102. The output of the pipeline is connected to the functional block 200 through a multiplexer 224. The input signals from the interconnect 226 are transmitted through the pipeline 108 to the controller 102 and also from the output of the pipeline 108 to one input of the multiplexer 224. The interconnect 226 is also directly connected to another input of the multiplexer 224. The multiplexer 224 is controlled by the controller 102 to selectively output either the signals from the interconnect 226 or the signals from the pipeline 108. The input signals passing through the pipeline 108 are delayed for “n” cycles (the pipeline has “n” pipeline registers), and therefore, the controller 102 has “n” cycles to reactivate the system clock 204 without losing any data.

In a further preferred form, the monitor signal may be remote to the functional block, and the reactivating condition associated with the monitored signal may be detected in an earlier time frame, so that the power control circuitry has enough time to reactivate the functional block. For example, as shown in FIG. 1, the power control block D may monitor a signal that is remote to the functional block 2. When the power control block D detects a reactivating condition associated to the monitored signal, the power control block D sends a control signal to the power control block A to reactivate the functional block 2 before the incoming data enter the functional block 2.

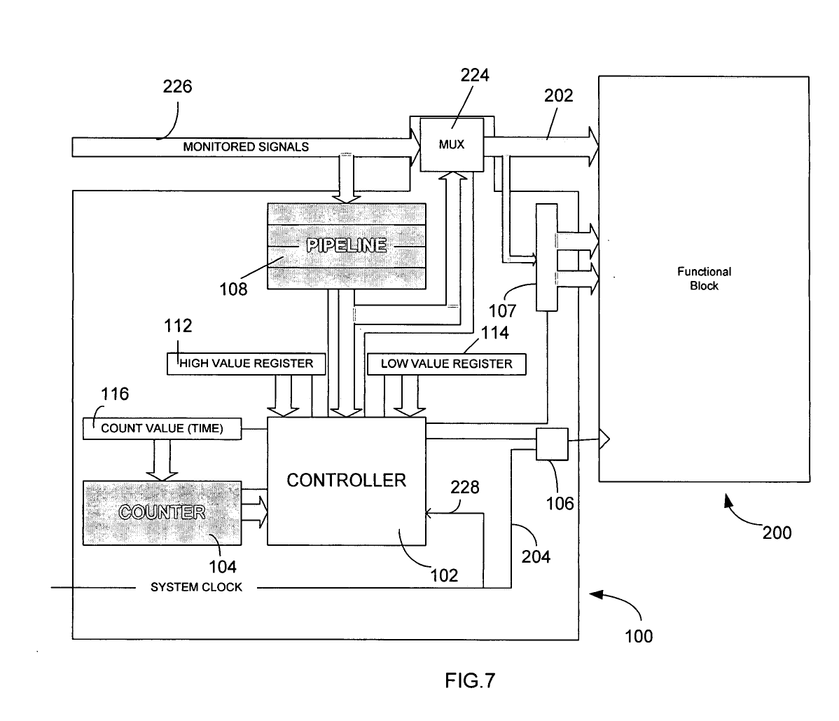

FIG.7 illustrates another embodiment of the present invention, in which the power management circuitry 100 is adaptive. In other words, the power management circuitry 100 is able to automatically adjust its logic or stored condition values, for example, the count value and the low and high numerical values, to achieve an optimal mode for power management for the functional block. For example, to be adaptive, the controller 102 is connected to the system clock 204 by an interconnect 228 to receive the clock signal from the system clock 204 for counting the number of cycles that the functional block 200 has been in the power saving mode, and based on this information, the controller 102 calculates the amount of energy saved. Then the controller 102 adjusts the logics or parameters of the stored predetermined conditions to achieve the optimal situation for power saving for the functional block.

As described above, the power management circuitry 100 can be configured with fixed logic circuits, or with at least partially reprogrammable logic circuits. The techniques for constructing reprogrammable logic circuits are described in detail below and also disclosed in the related patent application.

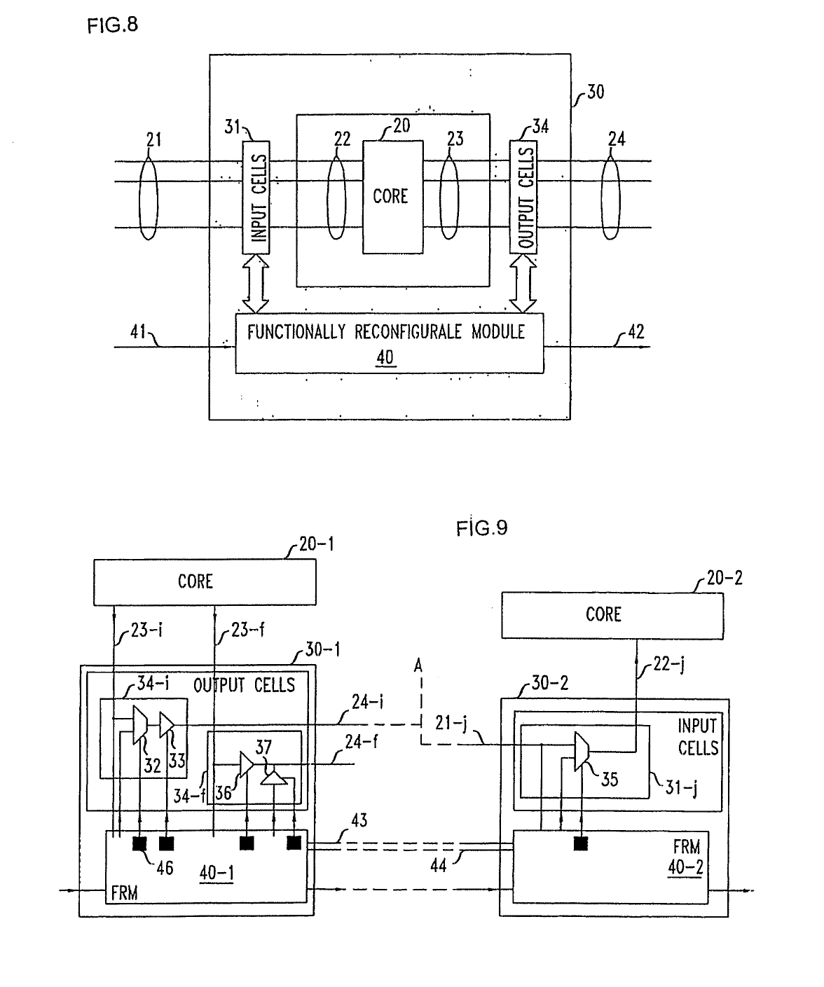

FIG. 8 presents a block diagram of a wrapped core of an integrated circuit, which is also disclosed in U.S. patent application Ser. No. 10/425,101, published with U.S. Patent Application Publication No. 2004/0212393, titled Reconfigurable Fabric for SoCs, filed on Apr. 28, 2003, which is hereby incorporated by reference. The integrated circuit includes a core 20 connected to a wrapper 30 which is at least partially reconfigurable, such that by changing the logic in the wrapper 30, a user can operationally modify at least a subset of the inputs and a subset of the outputs of the core 20. The reprogrammable wrapper 30 may also be configured to manage power consumption of the core 20.

The core 20 is used in a simple instance of a “system on a chip,” or SoC. The SoC communicates with the core 20 via inputs 21 and outputs 24. The core 20 includes input leads 22 and output leads 23. Certain of the input leads and/or output leads are selected, based on a user's design arrangement, to be coupled to the wrapper 30 for selectively making certain parts or functions of the core 20 easy to observe and control. In one embodiment shown in the diagram in FIG.8, all the input leads 22 are connected to the inputs 21 through the input cells 31 of the wrapper 30 and all the output leads 23 are connected to the outputs 24 through the output cells 34 of the wrapper 30.

The wrapper 30 includes a functionally reconfigurable module (FRM) 40 that is coupled to the input cell set 31 and the output cell set 34. The FRM 40 may be implemented with, for example, a field programmable array, and some control circuitry, where the functionality of the field programmable array is determined by the contents of a configuration memory that is part of the field programmable array. The FRM 40 also includes an input 41 (for example, a multi-lead bus) and an output 42, which, when daisy-chained through a set of wrappers in an SoC, enables all of the FRMs in the SoC to be configured through the connections between the wrappers. Thus, in accord with the principles disclosed herein, a flexible SoC is created with a REFAB (reconfigurable fabric), which is a set of wrappers each comprising a collection of input cells, output cells, and an FRM. The FRM includes field programmable logic and memory that configures the logic and the interconnections within the FRM.

It may be noted that the input cell set 31 and the output cell set 34 may be embedded within the FRM 40, but for purpose of illustration, FIG.8 shows the embodiment that has the input cells 31 and output cells 34 disposed outside the FRM 40.

FIG. 9 shows an exemplary structure of the output and input cells through an illustration of an SoC, which includes two cores 20-1 and 20-2 connected with each other on the integrated circuit. An output lead 23-i of the core 20-1 is connected to an input lead 22-j of the core 20-2 through reconfigurable wrappers. In accord with the wrapper paradigm disclosed herein, this connection is effected by passing through the wrapper of the core 20-1, i.e., the wrapper 30-1, and by passing through the wrapper of the core 20-2, i.e., the wrapper 30-2. The wrapper 30-1 includes an output cell 34-i, which is connected to the output lead 23-i of the core 20. The wrapper 30-2 includes an input cell 31-j, which is connected to the input lead 22-j of the core 20-2. The output cell 34-j has an output lead 24-i, which is connected to an input lead 21 -j of the input cell 31 -j.

In one preferred form, output cells within a wrapper are constructed as shown for cell 34-i. That is, a cell comprises a two-input multiplexer 32 that has one input connected to an output lead of the associated core. That same output lead of the core is also connected to the FRM of the wrapper, that is, the FRM 40-1 in FIG.9. The second input of the multiplexer 32 is connected to the FRM. In one preferred form as shown in FIG.9, the output of the multiplexer 32 is coupled to an output lead of the wrapper 30 through a three-state driver 33. The three-state driver 33 is characterized by a high output impedance when the control signal is low (logic level “0”). When the control signal is high (logic level “1”), the output of the driver 33 merely equals its input. Configuration memory bits within the FRM 40-1 (the solid squares in FIG. 9), such as the configuration bit 46, control the multiplexer 32 and the driver 33. The outputs of the multiplexer 32 and the driver 33 can be changed by changing the value of the configuration memory bits.

Alternatively, the output cells within a wrapper may be constructed as shown for the cell 34-f. As shown in FIG.9, the output cell 34-f includes a tri-state driver 36, which is connected to the output lead 23-f of the core 20-1 and is under control of a configuration bit in the FRM 40-1. The output of the tri-state driver 36 is connected to the output lead 24-f of the output cell. The output cell 34-f further includes another tri-state driver 37 which is adapted to output a signal generated within the wrapper to the same output 24-f and which is also under control of a configuration bit in the FRM 40-1. Of course, the configuration bits are never set so that both of the drivers 36 and 37 concurrently pass a signal to their respective outputs.

Input cells within a wrapper are constructed as shown for the cell 31 -j with, for example, a two-input multiplexer 35. The outer input lead 21-j of the wrapper is connected to one input of the multiplexer 35 and to the associated FRM. A second input to the multiplexer 35 is received from the FRM, and the output of the multiplexer 35 is connected to the input lead 22-j of the associated core. As with the cell 34-i, configuration bits within the FRM control the state of the multiplexer 35.

FIG. 9 presents an additional feature that confers significant advantages to the SoC fabric architecture disclosed herein, and that feature is spare lines 43 and 44 that connect the FRM of the wrapper 30-1 to the FRM of the wrapper 30-2. FIG. 9 shows only two spare lines, but it should be kept in mind that the FIG. 9 illustration may be depicting fewer than all of the connections between the wrappers 30-1 and 30-2, and that there also may be connections to other wrappers, and to user defined logic modules. The number of spare lines is a design choice. It is expected, however, that the number of spare lines between two wrappers will be directly proportional—though not necessarily in a mathematically precise relationship—to the number of signal lines that connect those wrappers in a particular SoC design.

To illustrate different output cell designs, FIG. 9 depicts two output cells for the wrapper 30-1. The first output cell 34-i includes a multiplexer 32 followed by a three-state driver 33. The second output cell 34-f includes two three-state drivers 36 and 37 that have their outputs coupled to the output of the cell. In the first output cell 34-i, the multiplexer 34 selects either a signal from the core 20-1 or a signal from within FRM 40-1, and the driver 34 either passes that signal to the cell's output or is disabled and thus presents a high impedance to the cell's output. In the second output cell 34-f, only one of the drivers is enabled at a time, and thus the output cell presents either a high impedance at its output, or the signal of the enabled driver, i.e., either a signal from the core 20-1, or a signal from the configuration bit within the FRM 40-1.

In one preferred form, the power management circuitry 100 is an independent circuit that is coupled to the functional block 200 and is configured with reprogrammable logic circuits as described above. Alternatively, the power management circuitry 100 is a part of a reconfigurable wrapper that is coupled to the functional block 200 not only to manage power consumption of the functional block 200, but also to modify the inputs and/or outputs of the functional block 200, and thereby to change the functionality of the functional block 200.

While the claimed invention has been described in detail and with reference to specific embodiments thereof, it will be apparent to one of ordinary skill in the art that various changes and modifications can be made to the claimed invention without departing from the spirit and scope thereof. Thus, for example those skilled in the art will recognize, or be able to ascertain, using no more than routine experimentation, numerous equivalents to the specific substances and procedures described herein. Such equivalents are considered to be within the scope of this invention, and are covered by the following claims.

Appendices that aid in understanding of the present invention are further incorporated within the present specification. Appendix A is a U.S. Patent Application Publication (Pub. No.: US 2004/0212393), which has been incorporated in this application by reference. Appendices B and C include Verilog HDL programs that implement the exemplary modules shown in the figures. In these two Appendices, Appendix B, which includes Verilog HDL codes together with a diagram of an exemplary module and pointers between the codes and the diagram, is a top level module containing registers, counter, and controller. Appendix C implements a shift register in a pipeline, which is incorporated in the program in Appendix B.

What is claimed is:

1. An autonomous power managing system for an integrated circuit, said integrated circuit comprising at least one functional block, said power managing system comprising: power management circuitry connected to said functional block, wherein said power management circuitry is configured to monitor at least one signal in said integrated circuit for detecting a predetermined condition associated with said signal, and, in response to said predetermined condition, to set said functional block to a power saving mode, and, in response to another predetermined condition associated with said signal, to set said functional block to a normal operational mode.

2. A system according to claim 1, wherein said power management circuitry comprises fixed logic circuits.

3. A system according to claim 2, said functional block being coupled to and driven by a system clock signal having a normal operation clock rate on which said functional block normally operates, wherein said power management circuitry is coupled to said system clock signal to reduce the clock rate of said system clock signal in response to said predetermined condition.

4. A system according to claim 3, wherein said power management circuitry is adapted to turn off said system clock signal in response to said predetermined condition.

5. A system according to claim 2, wherein said functional block includes an input for receiving an input signal, and wherein said power management circuitry is coupled to said input to disable said input signal to said functional block in response to said predetermined condition.

6. A system according to claim 1, wherein said power management circuitry comprises reconfigurable logic circuits.

7. A system according to claim 6, said functional block being coupled to and driven by a system clock signal having a normal operation clock rate on which said functional block normally operates, wherein said power management circuitry is adapted to reduce the clock rate of said system clock signal in response to said predetermined condition.

8. A system according to claim 7, wherein said power management circuitry is adapted to turn off said system clock signal in response to said predetermined condition.

9. A system according to claim 7, wherein said power management circuitry is coupled to at least one input of said functional block to disable at least one input signal to said functional block in response to said predetermined condition.

10. A system according to claim 1, wherein said power management circuitry is coupled to at least one input of said functional block to disable at least one input signal to said functional block in response to said predetermined condition.

11. A system according to claim 1, said functional block being coupled to and driven by a system clock signal having a normal operation clock rate on which said functional block normally operates, wherein said power management circuitry is adapted to reduce the clock rate of said system clock signal in response to said predetermined condition.

12. A system according to claim 11, wherein said power management circuitry is adapted to turn off said system clock signal in response to said predetermined condition.

13. A system according to claim 11, wherein said power management circuitry is coupled to and driven by a clock signal, wherein said clock signal has a clock rate which is greater than the normal operation clock rate of the system clock signal.

14. A system according to claim 11, wherein said power management circuitry is coupled to and driven by a clock signal, which is a phase-shifted version of the system clock signal with the normal operation clock rate.

15. A system according to claim 1, wherein said power management circuitry comprises a controller for monitoring said at least one signal and for setting said functional block to the power saving mode or the normal operational mode.

16. A system according to claim 15, wherein said controller comprises at least one register for storing information representative of said predetermined condition, and wherein said at least one register is user-settable.

17. A system according to claim 16, wherein said controller comprises a comparator for comparing said at least one signal to said information stored in said at least one register to determine whether said at least one signal is in said predetermined condition.

18. A system according to claim 16, wherein said at least one register comprises two registers respectively for storing a low numerical value and a high numerical value, and wherein said predetermined condition is that said at least one signal is outside said low and high numerical values, and said another predetermined condition is that said at least one signal is between said low and high numerical values.

19. A system according to claim 18, wherein said power management circuitry further comprises a counter connected to said controller, said counter including a register for storing information of a duration, wherein said predetermined condition is that said at least one signal is outside said low and high numerical values for said duration.

20. A system according to claim 15, wherein said power management circuitry further comprises a counter connected to said controller, wherein said counter includes a register for storing information representative of said predetermined condition.

21. A system according to claim 20, wherein said register is user-settable.

22. A system according to claim 1, wherein said power management circuitry is connected to at least one input of said functional block and monitors at least one input signal at said at least one input.

23. A system according to claim 22, wherein said power management circuitry includes a pipeline connected to said input.

24. A system according to claim 23, wherein said power management circuitry further includes a multiplexer connecting said input and an output of said pipeline to said functional block, wherein said multiplexer is configured to select signals either from said input or from said output of said pipeline to be fed into said functional block.

25. An autonomous power managing system for an integrated circuit, said integrated circuit comprising at least one functional block and a system clock having a clock signal driving said functional block, said clock signal having a normal operation clock rate on which said functional block normally operates, said power managing system comprising: power management circuitry distributed in said integrated circuit for locally managing power consumption of said functional block, wherein said power management circuitry is configured to monitor at least one signal in said integrated circuit for detecting a predetermined condition associated with said at least one signal, and, in response to said predetermined condition, to adjust said clock signal to the functional block to a lower clock rate, and, in response to another predetermined condition associated with said at least one signal, to restore the normal operational clock rate to said clock signal to said functional block.

26. A system according to claim 25, wherein said power management circuitry comprises a controller for monitoring said at least one signal, and in response to said predetermined condition or said another predetermined condition associated with said at least one signal, generating a clock control signal to control said clock signal.

27. A system according to claim 26, wherein said controller comprises at least one register for storing information representative of said predetermined condition, and wherein said controller comprises a comparator for comparing said at least one signal to said predetermined condition to determine whether said signal is in said predetermined condition.

28. A system according to claim 27, wherein said at least one register is user-settable.

29. A system according to claim 26, wherein said power management circuitry further comprises a counter connected to said controller, wherein said counter includes a register for storing information representative of said predetermined condition.

30. A system according to claim 29, wherein said register of said counter is user-settable.

31. A system according to claim 26 further comprising a clock control circuit connected to said controller for receiving said clock control signal and also connected to said system clock, wherein, in response to said clock control signal, said clock control circuit adjusts the clock rate of said clock signal.

32. A system according to claim 31, wherein said clock control circuit is adapted to turn off said clock signal to said functional block.

33. A system according to claim 32, wherein said clock control circuit comprises an AND gate, wherein said controller and said system clock are coupled to two inputs of said AND gate, and an output of said AND gate is coupled to said functional block.

34. A system according to claim 26, wherein said power management is coupled to at least one input of said functional block, and wherein said controller is connected to said at least one input for monitoring at least one input signal and detecting said predetermined condition associated with said input signal.

35. A system according to claim 34, wherein said power management circuitry further includes a pipeline connected between said at least one input and said controller.

36. A system according to claim 35, wherein said power management circuitry further includes a multiplexer connecting said at least one input and an output of said pipeline to said functional block, wherein said multiplexer is configured to select a signal either from said input or from said output of said pipeline to be fed into said functional block.

37. A system according to claim 26, wherein said power management circuitry further includes an input control circuit coupled between at least one input of said functional block and said functional block, wherein, said input control circuit is adapted to disable at least one input signal at said at least one input to said functional block in response to said predetermined condition, and in response to said another predetermined condition, to enable said at least one input signal to said functional block.

38. A system according to claim 25, wherein said power management circuitry is coupled to said system clock, and wherein said power management circuitry is adapted to count the duration for which said functional block is in the power saving mode.

39. A system according to claim 38, wherein said power management circuitry is adapted to calculate the amount of energy saved by the functional block in the duration for which said functional block is in the power saving mode.

40. A system according to claim 39, wherein said power management circuitry is adapted to automatically adjust parameters of said predetermined condition based on said amount of energy saved by said functional block to achieve an optimal energy saving mode for said functional block.

41. A system according to claim 25, wherein said power management circuitry is at least partially reconfigurable.

42. An autonomous power managing system for managing power consumed by a functional block in an integrated circuit, said functional block having an interface for communicating with outside of said functional block, said power managing system comprising:
a reconfigurable wrapper coupled to said interface of said functional block, wherein said reconfigurable wrapper comprises power management circuitry configured to monitor at least one signal at said interface for detecting a predetermined condition associated with said at least one signal, and, in response to said predetermined condition, to set said functional block to a power saving mode, and, in response to another predetermined condition associated with said at least one signal, to set said functional block to a normal operational mode.

43. A system according to claim 42, wherein said power management circuitry is connected to at least one input of said functional block for monitoring at least one input signal and detecting said predetermined condition associated with said input signal.

44. A system according to claim 43, wherein said power management circuitry is configured to disable said input signal to said functional block in response to said predetermined condition.

45. A system according to claim 44, said functional block being coupled to and driven by a system clock signal, wherein said power management circuitry is adapted to reduce the clock rate of said system clock signal in response to said predetermined condition.

46. A system according to claim 42, said functional block being coupled to and driven by a system clock signal, wherein said power management circuitry is adapted to reduce the clock rate of said system clock signal in response to said predetermined condition.

47. A system according to claim 46, wherein said power management circuitry is adapted to turn off said system clock signal in response to the detection of said predetermined condition.
